(19) United States
(12) Patent Application Publication
(10) Pub. No.: US 2017/0190297 A1
(43) Pub. Date: Jul. 6, 2017

(54) MOUNTING SYSTEM FOR SELF DEFENSE AND UTILITY EQUIPMENT

(71) Applicant: David M. Heuring, Wilmington, NC (US)

(72) Inventor: David M. Heuring, Wilmington, NC (US)

(21) Appl. No.: 15/221,319

(22) Filed: Jul. 27, 2016

Related U.S. Application Data
(60) Provisional application No. 62/213,106, filed on Sep. 2, 2015.

(51) Int. Cl. B60R 7/14; F41A 23/26; B60Q 9/00

(52) U.S. Cl. CPC B60R 7/14; B60Q 9/00; F41A 23/26

(57) ABSTRACT

A mounting device for a utility device may be attached to an undercarriage of seat in such a manner that it travels with the seat as the seat is adjusted forwards or backwards. The configuration thus maintains the weapon in reach of the driver, regardless of the height of the driver. More particularly, the system may attach underneath to a seat rail system so that as the seat is adjusted, the mounted weapon moves relative to the seat to maintain the spacing. An embodiment includes an alarm system that audibly and/or visually alerts a user if they leave an automobile in a weapon mounted within the system (e.g., without taking their gun from the holster). The mounting system may alternatively attach to a desk, beside table, or a wall, among other surfaces.

### I. CROSS REFERENCE TO RELATED APPLICATIONS

This application is a continuation application and claims priority from U.S. Provisional Patent Application No. 62/213,106, which is incorporated herein by reference in its entirety.

### II. FIELD OF THE DISCLOSURE

The present disclosure relates generally to equipment used emergency and self-defense situations, as well as processes for manufacturing the same.

### II. BACKGROUND

Emergency responders, such as policemen, constantly put their lives at risk to protect the public, and in so doing, being targets, themselves. Many responders are most vulnerable when approaching a scene in a vehicle. For instance, a police officer may be initially most assailable when strapped via seat belt in a cruiser at the scene of a gunfight. The police may have only a few seconds to recognize a threat, to free themselves of a seat belt and jacket, and to access their firearm from their duty belt. In the meantime, the police officer is susceptible to attack from an assailant.

### IV. SUMMARY OF THE DISCLOSURE

According to an embodiment, an apparatus includes a first elongated section and a first fastener configured to attach the first elongated section to an undercarriage of a vehicle seat. A second elongated section extends in a vertical relation up from the first elongated section. A second fastener is configured to attach the second elongated section to a removable utility device.

According to a particular implementation, the first and second elongated sections are attached to one another. In another embodiment, the first and second elongated sections are formed integrally. The removable utility device may include at least one of a holster, a strap, a flashlight, a hook, an aperture, a clip, and a self-defense weapon.

According to an embodiment, the undercarriage is one of a plurality of different undercarriages to which the first fastener is configured to attach. An alarm may be configured to audibly or visually alert a user if the utility device is left mounted when the user exits a vehicle. A first elongated section may attach using bolts of the undercarriage. A second fastener may allow the adjustment of the utility device. For example, the second fastener includes a ratchet mechanism. At least one of the first elongated section and the second elongated section may be adjustable in length.

According to another embodiment, an apparatus includes a mounting segment extending in a first direction, where the mounting segment includes at least three connection points for attachment to a stationary structure. An attachment segment may extend in substantially the same direction and have a fastener configured to attach the attachment segment to a removable utility device. An intermediate segment may connect to the mounting segment to the attachment segment, and a first fastener may be configured to attach to the attachment segment and the removable utility device.

According to an implementation, the utility device is positioned between the mounting segment and the attachment segment when attached to the attachment segment. The mounting segment, attachment segment, and intermediate segment may be formed integrally. The intermediate section may be substantially U-shaped. In an example, the fastener enables the adjustment of the utility device. A mounting fastener may be configured to mount to the stationary structure.

According to another embodiment, a method of manufacturing a utility device includes positioning a first elongated section and attaching the first elongated section to an undercarriage of a vehicle seat. A second elongated section may be positioned to extend at vertical relation up from the first elongated section and may be attach the second elongated section to a removable utility device.

According to an implementation, a cant of the utility device may be adjustable by a user. The undercarriage may be one of a plurality of different undercarriages to which the first fastener is configured to attach. A length of at least one of the first elongated section and the second elongated section may be adjustable.

Features and other benefits that characterize embodiments are set forth in the claims annexed hereto and forming a further part hereof. However, for a better understanding of the embodiments, and of the advantages and objectives attained through their use, reference should be made to the Drawings and to the accompanying descriptive matter.

### V. BRIEF DESCRIPTION OF THE DRAWINGS

FIG. 1 shows a perspective view of a mounting system configured to attach to an undercarriage of a vehicular seat;

FIG. 2 shows perspective view of an embodiment of a mounting system for a utility device that may attach to a stationary structure in an adjustable and secure manner;

FIG. 3 shows another perspective view of a mounting system that may be similar or identical to the mounting system of FIG. 2; and

FIG. 4 shows another perspective view of a mounting system that may be similar or identical to the mounting systems of FIG. 2 or 3.

### VI. DETAILED DESCRIPTION

An embodiment of the present mounting system puts a defensive weapon or utilitarian tool in an ergonomic and unobstructed position for access to a user. Another or the same embodiment may be adaptable to virtually any type of equipment having a holster or clip. Moreover, the system may be attached to universally to different vehicle models and other types of structures. The mounting system may save emergency personal critical seconds in responding to a life threatening situation. For example, a policeman using an embodiment of the mounting system may retrieve and present their revolver in under a second.

According to an implementation, the system may be mounted (e.g., bolted) to a rail system or other undercarriage of seat in such a manner that it travels with the seat as the seat is adjusted forwards or backwards. The configuration thus maintains the weapon in reach of the driver, regardless of the height of the driver. More particularly, the system may attach underneath to a seat rail system so that as the seat is adjusted, the mounted weapon moves relative to the seat to maintain the spacing. An embodiment includes an alarm system that audibly and/or visually alerts a user if they leave an automobile in a weapon mounted within the system (e.g., without taking their gun from the holster). The mounting system of another embodiment mounts to a desk, beside table, or a wall.

An embodiment of the mounting system may universally attach to any number of vehicles models and structures, such as different chair rail or microphone mount configurations of a various squad cars. Embodiments of the mounting system may use existing front seat cushion bolts that hold the seat cushion on the adjustable rails/undercarriage. In this manner, it is not necessary to modify a vehicle as an embodiment is compatible with existing seat screws.

An embodiment of the mounting system may include a holster having an adjustable cant angle to optimize the draw angle in accordance with a seating position of a user. An adjustment screw may be tightened or loosened to allow a 360 degree rotation. The adjustable feature may be a part of the holster or may be part of the mounting system. The fastener, such as a screw, may ratchet for securement. Loosening the screw may separate gear teeth of a ratchet mechanism to permit adjustment of the cant angle. The attachment may be utilized for rigid and semi-rigid holsters. When a police department changes a duty weapon, the universality ensures that the holsters may be detached and sold along with the guns. Besides firearms, the mounting system may be used for tasers, mace, and flashlights, among other devices that include a holster, clip, aperture, or other fastening structure configured to be attached to an upward extending section of the mounting system.

According to a particular embodiment, the mounting system includes an elongated section having apertures to fastening to different seat configurations. The elongated section may be attached to a forward portion of the seat in one implementation. The length of the elongated section may discourage pivoting and aid in stability. The fastening mechanism may keep the mounting system stable in the event of a car crash. A jogging section of the mounting system may extend out from under the seat before a vertical section extends about the seat. The jogging section may avoid a center console and allow for a faster draw.

An embodiment of the mounting system may be stamped from a single piece of metal or be constructed from a plastic or composite material. Another embodiment may include may include a track system and that may be attached with bolts or other fasteners. One or more portions may slide over other one or more section to extend the mounting system in height or length or width. This feature may further provide a universal fit to different automobiles and other environments.

A compact version of the mounting system may fasten to a radio console, desk, or any substantially flat surface. The mounting system may be bent or otherwise formed from a single piece of material. Three fasteners may secure one end of the mounting system to the surface. Once mounted, as with other embodiments, the cant may be adjusted using an adjustment crew or other selector.

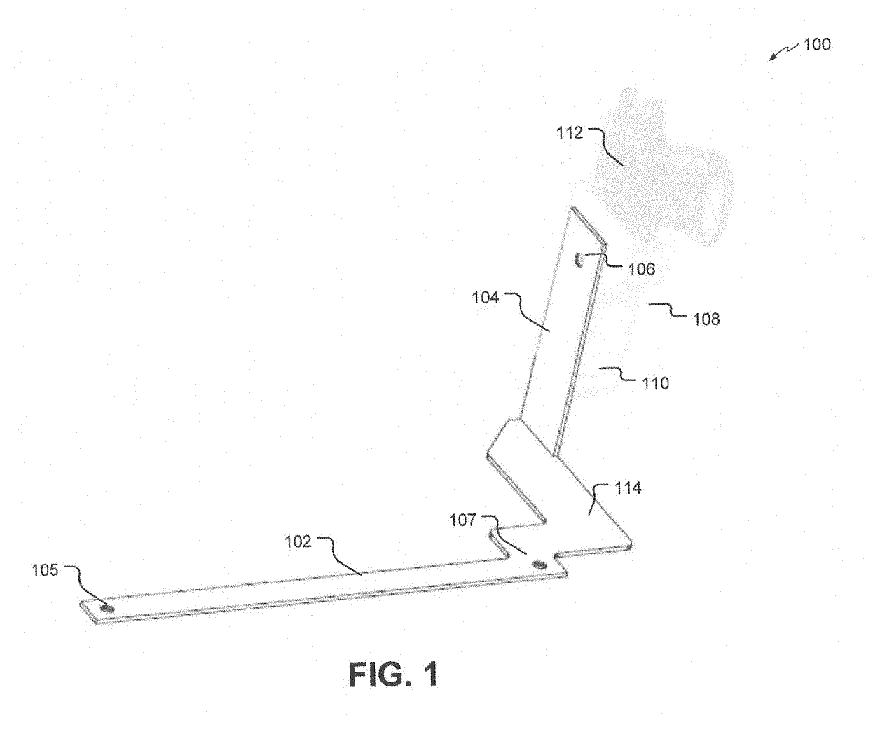

Turning more particularly to the Drawings, FIG. 1 shows a perspective view of a mounting system 100 configured to attach to an undercarriage of a vehicular seat. The mounting system 100 includes a first elongated section 102 and a second elongated section 104. One or more fasteners, such as a bolts (not shown), may be used to attach the first elongated section 102 to the undercarriage (not shown) of a vehicle seat. For instance, bolts may attach via apertures (e.g., connection points) 105, 107 in the first elongated section 102. In one implementation, the apertures 105, 107 may align with corresponding apertures in the undercarriage and may use existing undercarriage bolts.

According to a particular embodiment, the first elongated section 102 aligns substantially with a forward facing portion of an undercarriage seat. Positioning the first elongated section 102 as such may maintain the orientation of the mounting system 100 with respect to a user as the seat position is adjusted.

The second elongated section 104 may extend in a vertical relation up from the first elongated section 102. A second fastener (not shown) is configured to attach via an aperture 106 the second elongated section 104 to a removable utility device 108 comprising a holster 110 and firearm 112. Placement of the aperture 106 and second fastener may allow the adjustment of the utility device 108. For example, a user may adjust a cant of the utility device 108. To this end, the second fastener may include a ratchet (not shown) having adjustable gears or another adjustable mechanism to set a desired orientation of the utility device 108.

A jogging section 114 of the mounting system 100 may extend from the first elongated section 102 in one or more directions before connecting to the second elongated section 104. The one or more directions of an embodiment may be in the same plane as the first elongated section 102. For example, the jogging section 114 of FIG. 1 includes a bend portion 116. A jogging section of another embodiment may additionally or alternatively extend vertically or horizontally. The jogging section 114 may position the second elongated section 104 out from under a seat in such a manner as to avoid a center console and allow for a faster draw.

The jogging section 114 and the first and second elongated sections 102, 104 are connected to one another in FIG. 1. One or more of the sections 102, 104, 114 of an embodiment are welded. In another implementation, one or more of the sections 102, 104, 114 may be fastened together mechanically or may be created by folding a single piece of metal. Still another embodiment may include sections molded or formed integrally from one or more pieces of polymer, fiber, composite, or plastic, among other materials.

Other embodiments of the mounting system may include additional apertures and/or sliding mechanisms to enable attachment to different types of undercarriages. For example, a sliding section may slide in a tongue and groove fashion over an extending section and may be secured by a bolt or gear teeth to adjust the effective length of the section. Another implementation may include an adjustable length segment having apertures that align with the elongated segment to be bolted on to add onto the length. An alarm may be configured to audibly or visually alert a user if the utility device is left mounted when the user exits a vehicle. For instance, a weight sensor or a radio frequency identification (RFID) mechanism may detect if the utility device has been left in the mounting system as user exits a vehicle.

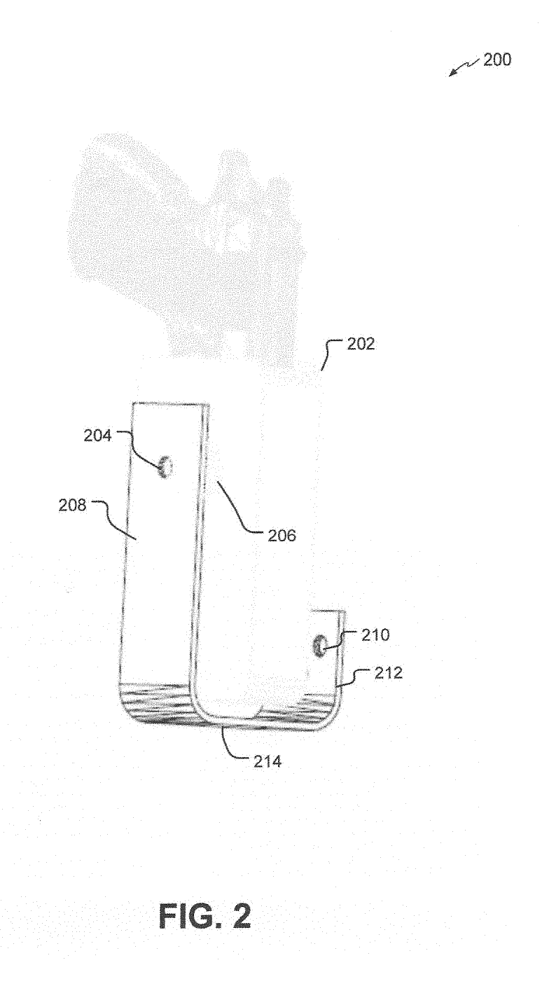

FIG. 2 shows perspective view of an embodiment of a mounting system 200 for a utility device 202 that may attach to most any stationary structure in an adjustable and secure manner. An aperture 204 is configured to be used in conjunction with a bolt (not shown) or other fastener to attach to the utility device 202. The removable utility device 202 may include at least one of a holster, a strap, a flashlight, a hook, an aperture, a clip, and a self-defense weapon.

The aperture 204 or other fastener fastening mechanism may allow the adjustment of the utility device 202. For example, the fastener may include a ratchet mechanism 206.

According to another embodiment, the mounting system 200 includes a mounting segment 208 extending in a first direction. As described herein, the mounting segment 208 may include connection points 210 for attachment to a stationary structure (not shown). An attachment segment 212 may extend in substantially the same direction and include the aperture 204 configured to attach the attachment segment 212 to the removable utility device 202. An intermediate segment 214 may connect to the mounting segment 208 to the attachment segment 212.

When mounted, the utility device 202 is positioned between the mounting segment 208 and the attachment segment 212. The mounting segment 208, attachment segment 212, and intermediate segment 214 may be formed integrally. The intermediate segment 214 may be substantially U-shaped.

As with all embodiments described herein, the mounting system 200 may be constructed from virtually any rigid or semi-rigid material, to include metal, wood, and plastic. The lengths and thicknesses are illustrative, and actual dimensions may vary per environmental factors and preferences. Additionally, the mounting system 200 may accommodate any type of holster or other equipment having any type of known fastener comprising its connection points.

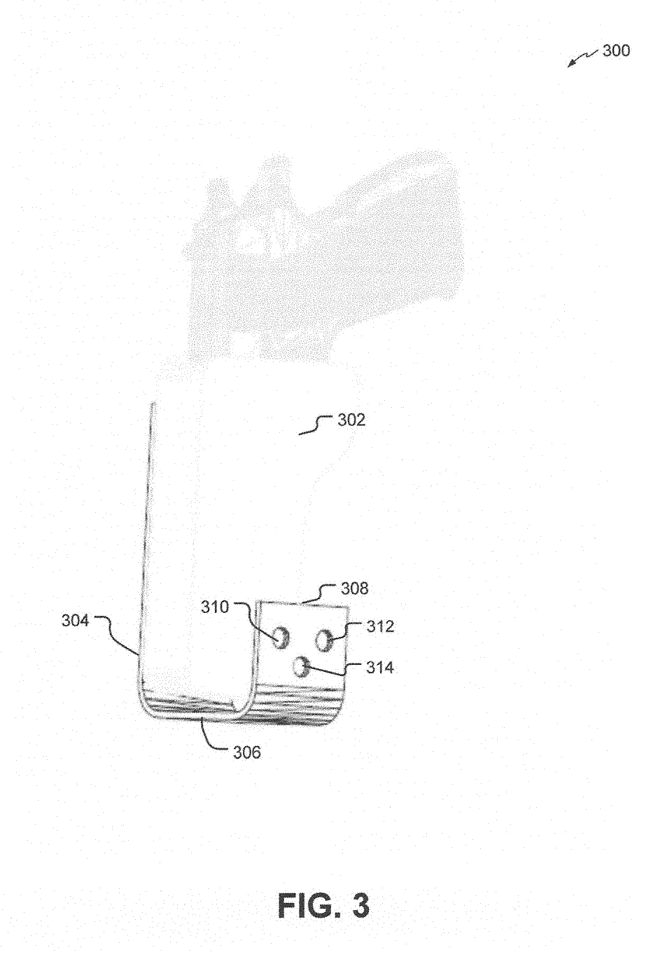

FIG. 3 shows a perspective view of a mounting system 300 that may be similar or identical to the mounting system 200 of FIG. 2. A removable utility device 302 is mounted between a mounting segment 304, an attachment segment 306, and an intermediate segment 308. More particularly, the removable utility device 302 may be attached to the attachment segment 306 via a connection point (not shown). The mounting segment 304 includes connection points 310, 312, 314. As shown in FIG. 3, the connection points 310, 312, 314 comprise apertures through which screws, nails, bolts, or other fasteners may attach the mounting system 300 to a flat surface, such as a wall or table leg.

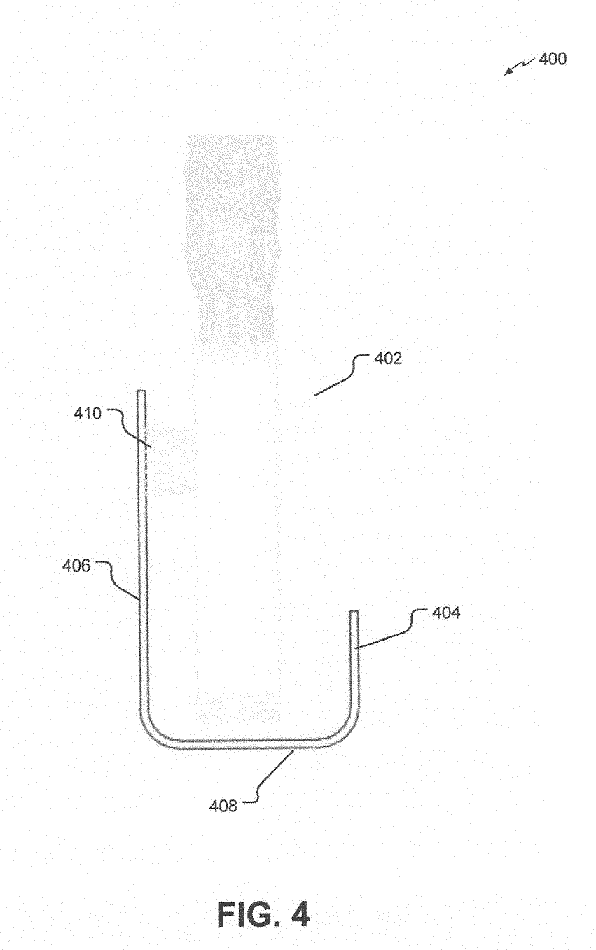

FIG. 4 shows a perspective view of a mounting system 400 that may be similar or identical to the mounting systems 200, 300 of FIG. 2 or 3. As in FIG. 3, a removable utility device 402 is mounted between a mounting segment 404, an attachment segment 406, and an intermediate segment 408. More particularly, the removable utility device 402 may be attached to the attachment segment 406 via a connection point using a connection point 410 comprising a ratchet mechanism.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

1. An apparatus comprising:
a first elongated section;
a first fastener configured to attach the first elongated section to an undercarriage of a vehicle seat;
a second elongated section extending in vertical relation up from the first elongated section, and
a second fastener configured to attach the second elongated section to a removable utility device.

2. The apparatus of claim 1, wherein the first and second elongated sections are attached to one another.

3. The apparatus of claim 1, wherein the first and second elongated sections are formed integrally.

4. The apparatus of claim 1, wherein the removable utility device includes at least one of a holster, a strap, a flashlight, a hook, an aperture, a clip, and a self-defense weapon.

5. The apparatus of claim 1, wherein the undercarriage is one of a plurality of different undercarriages to which the first fastener is configured to attach.

6. The apparatus of claim 1, further comprising an alarm configured to audibly or visually alert a user if the utility device is left mounted when the user exits a vehicle.

7. The apparatus of claim 1, wherein the first elongated section attaches using bolts of the undercarriage.

8. The apparatus of claim 1, wherein the second fastener allows the adjustment of the utility device.

9. The apparatus of claim 1, wherein second fastener includes a ratchet mechanism.

10. The apparatus of claim 1, wherein at least one of the first elongated section and the second elongated section is adjustable in length.

11. An apparatus comprising:
a mounting segment extending in a first direction, wherein the mounting segment includes at least three connection points for attachment to a stationary structure;
an attachment segment extending in substantially the same direction and having a fastener configured to attach the attachment segment to a removable utility device;
an intermediate segment connecting the mounting segment to the attachment segment; and
a first fastener configured to attach to the attachment segment and the removable utility device.

12. The apparatus of claim 11, wherein the utility device is positioned between the mounting segment and the attachment segment when attached to the attachment segment.

13. The apparatus of claim 11, wherein the mounting segment, attachment segment, and intermediate segment are formed integrally.

14. The apparatus of claim 11, wherein the intermediate section is substantially U-shaped.

15. The apparatus of claim 11, wherein the fastener enables the adjustment of the utility device.

16. The apparatus of claim 11, further comprising a mounting fastener configured to mount to the stationary structure.

17. A method of manufacturing a utility device, the method comprising:
positioning a first elongated section;
attaching the first elongated section to an undercarriage of a vehicle seat;
positioning a second elongated section to extend at vertical relation up from the first elongated section, and
attaching the second elongated section to a removable utility device.

18. The method of claim 17, further comprising enabling a cant of the utility device to be adjustable by a user.

19. The apparatus of claim 17, wherein the undercarriage is one of a plurality of different undercarriages to which the first fastener is configured to attach.

20. The apparatus of claim 17, further comprising enabling a length of at least one of the first elongated section and the second elongated section to be adjustable.
